(19) United States
(12) Patent Application Publication
(10) Pub. No.: US 2013/0206968 A1
(43) Pub. Date: Aug. 15, 2013

(54) METHOD TO FACILITATE POSITIONING OF DIFFRACTION SPOTS

(71) Applicant: Jean-Luc Rouviere, Meylan (FR)

(72) Inventor: Jean-Luc Rouviere, Meylan (FR)

(73) Assignee: COMMISSARIAT A L'ENERGIE ATOMIQUE ET AUX ENERGIES ALTERNATIVES, PARIS (FR)

(21) Appl. No.: 13/877,904

(22) PCT Filed: Oct. 4, 2011
(86) PCT No.: PCT/EP2011/067291

§ 371 Date: Apr. 4, 2013

(30) Foreign Application Priority Data
Oct. 4, 2010 (FR) 10 58031

(51) Int. Cl. G01N 23/00

(52) U.S. Cl. CPC G01N 23/00
USPC 250/216

(57) ABSTRACT

A method to facilitate positioning of diffraction spots in a diffraction pattern. This method comprises the following successive steps: a) obtaining a diffraction pattern by illuminating at least part of a sample comprising at least one periodic zone by an incident radiation beam that can be diffracted by said at least one periodic zone of the sample, and by placing a detector on the path of the beam thus diffracted; b) positioning of diffraction spots present on the diffraction pattern obtained in step a), by determining the spatial coordinates of these spots on the detector. Step b) is facilitated by the use of means in step a) to modify the shape and increase the contour length of diffraction spots forming on said pattern.

### TECHNICAL DOMAIN

The invention relates to a particular method to facilitate positioning of diffraction spots in a diffraction pattern.

Such a method has various technological applications, for example such as measurement of deformations in a crystalline sample at microscopic or smaller scale, or measurement of the precise orientation of a crystalline sample.

### STATE OF PRIOR ART

Many techniques for characterisation and analysis of materials at a microscopic or smaller scale make use of diffraction spots in order to precisely determine the structural properties of these materials.

For example, there is the case of electron beam microscopy and X-ray beam microscopy.

A large amount of information about the structure of a material can be found by precisely positioning the diffraction spots of the material in a diffraction pattern. For example, the distribution of diffraction spots provides means for determining the nature of the crystalline system by providing values of lattice parameters (a,b,c) and values of angles (α,β,γ). Symmetries of the crystalline lattice, its crystalline orientation or the presence of deformations and dislocations within the material can also be determined.

Normally, the position of diffraction spots is determined by identifying the position of the intensity peak, and more precisely the position of the maximum intensity, for each diffraction spot. This is usually done by adjusting a mathematical function (parabolic or Gaussian or Lorentzian function, etc.) to the intensity of the diffraction peak. The maximum intensity of the adjusted function then determines the position of the maximum intensity peak. It is thus observed that the precision of the measurement of the intensity peak depends essentially on the width of the diffraction spots.

It can then be understood that it is advantageous to have an incident beam as parallel as possible, in order to obtain spots in the form of dots instead of disk-shaped diffraction spots, which are then easier to position and do not overlap even when there are many of them.

There are different means for obtaining point diffraction spots.

For example in X-ray diffraction, all that is necessary is to use a polychromatic incident beam (diameter d) and to position a detector behind the sample at a distance L from it. In practice, since the divergence of the beam is small (typically less than 17 mrads), the dimension of the diffraction spots (in other words their width at half-height) and the diameter of the incident beam are of the same order of magnitude.

When lenses can be used, as is the case in electron microscopy, a diffraction pattern is made simply in the focal plane of the first lens (so-called objective lens) (or in any plane conjugate to this focal plane) located behind the sample. In this case, the dimension of the diffraction spot is not related to the size of the incident beam, but rather to the size of the condenser diaphragm located in a plane conjugate to the focal plane of the objective lens. Point diffraction spots are then obtained by reducing the aperture size of the condenser diaphragm.

However, when the size of the diffraction spots is reduced to obtain point diffraction spots, diffraction peaks are obtained with very large intensities compared with the intensities of spot-free regions in the diffraction pattern.

This large variation of intensity between spot regions and spot-free regions would theoretically require the use of very large range detectors, in other words detectors with a range of more than 16 bits (equivalent to about 65000 counts). If conventional 16-bit detectors are used, high intensities of some diffraction peaks can saturate the detector and prevent positioning of these peaks.

However, detectors with a range of more than 16 bits are still relatively recent, they have very large pixel sizes and are very expensive. For example, there are 20-bit detectors for the detection of X-rays, but there are fewer pixels and they are larger than in more conventional detectors (172×172 μm² for 20-bit detectors compared with 15×15 μm² for conventional detectors).

Furthermore, the position of intensity maxima is sensitive to dynamic effects, especially in the case in which the beams are electron beams. Therefore the result of increasing dynamic effects is a deterioration in the precision of measurements of positions of maximum intensities.

Thus, 16-bit detectors are still used and when they are insufficient, tricks have to be used to prevent pixel saturation, for example such as <<anti-blooming>> or the acquisition of several identical diffraction patterns obtained at very short times, and then adding these patterns.

Another problem that can arise is that if the size of diffraction spots is reduced, the size of the spot can be less than the size of the detector pixel, so that high precision positioning of diffraction spots is no longer possible because positioning then depends on the pixel size.

Furthermore, reducing the size of the diffraction spots makes it possible to confuse low intensity point spots with noise, which eventually leads to a loss of precision in measurements.

Therefore, the inventor set himself the objective of designing a method to facilitate positioning of diffraction spots, to avoid the disadvantages mentioned above.

### Presentation of the Invention

This purpose is achieved by a method to facilitate positioning of diffraction spots present on a diffraction pattern, said method comprising the following successive steps:

a) obtaining a diffraction pattern by illuminating at least part of a sample comprising at least one periodic zone by an incident radiation beam that can be diffracted by said at least one periodic zone of the sample, and by placing a detector on the path of the beam thus diffracted;

b) positioning of diffraction spots present on the diffraction pattern obtained in step a), by determining the spatial coordinates of these spots on the detector;

and characterised in that step b) is facilitated by the use of means in step a) to modify the shape and increase the contour length of diffraction spots forming on said pattern.

The spatial coordinates of diffraction spots can be determined by positioning of the contour of the diffraction spots.

Naturally, a change in the shape and an increase in the contour length of the diffraction spots should be considered as a function of the shape and the contour length that said diffraction spots would have had in the absence of said means.

The incident beam may for example be a light beam, an X-ray beam, a neutron or ion beam, or an electron beam.

A diffraction pattern is obtained by illumination of at least part of the sample, this part containing at least one periodic zone, but obviously the entire sample can also be illuminated.

The periodic zone of the sample may for example be a crystalline lattice.

It should be noted that steps a) and b) above may be repeated at several locations in the sample, thus obtaining several diffraction patterns. This is particularly useful for making orientation or deformation maps of the sample.

It should also be noted that the contour of a body (two-dimensional) is composed of the line(s) that delimit this body. Therefore the contour length of a body is the perimeter of this body. The contour in the special case of a hollow body, for example as shown in FIG. 1D, is obtained considering the outside line(s) and the inside line(s).

As we have already seen in the section dealing with state of prior art, diffraction of a beam by a crystalline sample provides a diffraction pattern comprising diffraction spots in the shape of a dot or a more or less uniform solid disk. The purpose of the invention is to give a characteristic and recognisable shape to the diffraction spots through the use of means for modifying the shape and increasing the contour length of the diffraction spots, so that they can be easily identified and distinguished from any other spots that might be present on the diffraction pattern (noise), but that do not originate from diffraction of the sample. Therefore, by modifying the shape and extending the contour of diffraction spots, it will become easier to recognise them and to differentiate them from noise. The key point of the invention is that all diffraction spots will have the same shape, for example corresponding to the motif of the opening(s) formed in a plate placed between the incident beam source and the sample and acting as a diaphragm or, for example, corresponding to rings in the case of precession of the incident beam by a constant angle.

Diffraction spots can be more easily positioned after modifying their shape and increasing their contour length. In particular, they may be identified by algorithms developed to recognise and position a special shape corresponding to the shape of the diffraction spots.

According to a first embodiment, the means for modifying the shape and increasing the contour length of diffraction spots consist of a plate comprising at least one opening, said plate being placed on the path of the incident beam between the source of said incident beam and the sample such that the incident beam passes through said at least one opening before reaching the face of the sample, said at least one opening forming a motif that is reproduced in each diffraction spot of the pattern obtained in step b). Each spot in the diffraction pattern will thus be a copy or a replica of the motif present on the plate and formed by the single opening or all the openings. For example, if the motif is a five-point star, each spot will be in the form of this five-point star. Note that when it is stated that the motif is a copy or replica of the shape of each of the diffraction spots in the diffraction pattern, this means that the motif and the diffraction spots have the same shape factored by a proportioning factor. Note also that in some cases, the intensity of some parts of the motif may be low and these parts are not easily seen.

The plate may be a plane or curved element. It is frequently called a diaphragm.

Advantageously, each opening among said one or more openings has a contour formed by an alternation of concave portions and convex portions. The concave and convex portions may be segments of curves or segments of straight lines. The opening(s) may thus be polygons. The contour of the openings may also be a series of straight, concave and convex portions alternating around a circumference.

Advantageously, the motif has angular symmetry. For example, as shown in FIG. 1A, the motif is composed of an opening in the shape of a regular star with four points. In this case, there is an angular symmetry of 90°.

Advantageously, when the motif is formed of a single opening, the motif may represent any plane geometric element with a surface area S and for which the contour length is greater than the contour length of a circle with the same area S. Thus, for a circle with area S, the contour length will be greater than the perimeter of this circle with area S, in other words greater than 2\sqrt{πS}.

Advantageously, when the motif is formed of several openings, the motif may represent a set of plane geometric elements separated from each other, the sum of the contour lengths of elements of the assembly being greater than the contour length of a circle for which the area is equal to the sum of the areas of the elements of the assembly, in other words greater than 2\sqrt{πS}.

When the motif is composed of several small openings instead of a single large opening, it allows for the contour length of the motif to be further increased without increasing its overall size, namely the longest distance between the parts furthest from each other (the diameter in the case of a circular opening).

Advantageously, the shape of the motif is chosen from among a completely or partially barred circle, a star, a completely or partially barred star.

According to a second embodiment, the means for modifying the shape and increasing the contour length of the diffraction spots apply a translation and/or rotation movement to the incident beam, to the sample, to the diffracted beam or to the detector. Application of a translation and/or rotation movement to the incident beam may cause distortion of said incident beam.

According to a first variant, the means for modifying the shape and increasing the contour length of the diffraction spots apply a rotation movement to the incident beam to make it precess by an angle αₚ about an axis uₚ passing through the source and through the sample. A precession movement is thus applied to the incident beam about a determined axis. This axis is preferably perpendicular to the plane in which the sample is located. This axis is preferably perpendicular to the sample face on which the beam is incident.

According to a second variant, the means for modifying the shape and increasing the contour length of the diffraction spots apply a rotation movement to the sample so that the sample precesses by an angle αₚ about an axis uₚ passing through the source and the detector.

Advantageously, the precession angle αₚ (of the sample or the incident beam) is constant.

The precession angle αₚ may also vary as a function of an angle θ, the angle θ corresponding to the angular orientation of the incident beam in a plane perpendicular to the axis uₚ relative to a fixed straight line located in this plane.

Preferably, the precession angle αₚ is less than the Bragg angles of the diffracted beams. For example, in an electron microscope operating at 300 kV, the smallest Bragg angles are of the order of 0.5 and precession angles from 0.01 to 0.3° are perfectly suitable.

Preferably, the sample is prepared so that it is in the form of a slide with approximately parallel faces.

It should be noted that the sample may be entirely crystalline, or otherwise it may only contain one or several more or less extended crystalline regions (these regions may be very small, of the order of a few cubic nanometers). For example, the sample may be a polycrystalline sample. It may also be composed of powder or small particles deposited on a membrane. In this case, the sample may be prepared and placed such that the incident beam reaches these different crystalline regions in sequence in order to produce point by point maps of the sample (one diffraction pattern at each point).

Note that it is also possible to obtain diffraction spots with a particular shape by giving this particular shape to the incident beam by using lenses. Thus, according to one variant of the invention, the means for modifying the shape and increasing the contour length of the diffraction spots uses one or several electromagnetic lenses.

There are other variants that are described in the part entitled “Detailed presentation”.

### BRIEF DESCRIPTION OF THE DRAWINGS

The invention will be better understood and other advantages and special features will appear after reading the following description, given as a non-limitative example, accompanied by the appended drawings among which:

FIGS. 1A to 1G show several examples of different applicable contour shapes according to the invention;

FIG. 2A shows a diffraction spot obtained in a normal case with a beam without precession (comparison case not forming part of the invention), and FIGS. 2B and 2C show special cases according to the invention in which the diffraction spot is obtained either after the beam has been subjected to precession by a constant angle or after the beam has been subjected to precession by a variable angle as a function of the orientation of said beam;

FIG. 3A shows a diffraction spot obtained in a normal case with a beam without translation of the detector (FIG. 3A) (comparison case not forming part of the invention) and FIGS. 3B and 3C show special cases according to the invention that show the diffraction spot obtained when the detector is translated to form a circle (FIG. 3B), part of a circle (FIG. 3D) or a more complex figure (FIG. 3C) in which the contour length is increased;

FIGS. 4A and 4B show a diffraction pattern obtained according to prior art and a diffraction pattern as it could be obtained according to the invention by translation of the detector, respectively;

FIG. 5A shows a simulation of a conventional diffraction pattern for a silicon sample producing diffraction spots in the form of disks;

FIG. 5B shows a simulation of a diffraction pattern obtained according to one embodiment of the invention by applying a precession to the incident beam by a determined angle and producing diffraction spots in the form of rings;

FIG. 5C shows values of deformations measured on diffraction patterns for different thicknesses of silicon samples, depending on whether the diffraction patterns are obtained traditionally or by using the method according to the invention.

### DETAILED PRESENTATION OF PARTICULAR EMBODIMENTS

The method according to the invention discloses a different manner of positioning diffraction spots, based on positioning the particular shape of the spots rather than positioning a maximum intensity, or at each isocontour of diffraction spots if thresholding is applied to each diffraction spot.

The incident beam may be an X-ray beam, or a neutron beam or an ion beam. Preferably, the incident beam will be an electron beam. In the case of X-rays, the beam will preferably be a white beam, in other words it will be composed of several wavelengths so as to obtain diffraction patterns containing many diffraction spots.

It should be noted that the diffraction patterns are usually obtained with a spatially coherent incident beam. Remember that a spatially coherent incident beam, as is well known to those skilled in the art, is a beam formed from rays that are in phase and their wave functions (and not their intensity) are additive when the rays are superposed. But the method according to the invention is also applicable to a periodic sample illuminated by a spatially incoherent beam. For example, as soon as an image of a periodic sample is made with a system of lenses, a pattern composed of point spots—in other words diffraction spots—is formed in the focal plane of the lens system that signals the periodicity of the structure, regardless of whether or not the incident beam is coherent. Therefore, it is found that increasing the contour length of the diffraction spots is also useful in the case of a spatially incoherent incident beam.

The method according to the invention is applicable to any diffraction technique, for example X-ray diffraction, electron microscopy, neutron diffraction, etc. Therefore, for example diffraction patterns could be obtained using a scanning or transmission electron microscope.

As we have seen above, there are different possible variants for modifying the shape and increasing the shape contour of diffraction spots. The choice of a particular variant is made as a function of the nature of the incident beam, the equipment available to make the diffraction, or the precision or speed of the measurement to be obtained.

In fact, a distinction can be made between two different ways of making diffraction patterns, namely conventional diffraction and source diffraction.

Conventional diffraction consists of forming a diffraction pattern in the focal plane of a lens (therefore this method requires the use of lenses).

Source diffraction consists of recording the image of a point source and source images reflected by the different crystallographic planes of the sample.

When it is required to modify the shape and increase the contour length of the diffraction spots using a diaphragm according to one of the possibilities of the invention, the diaphragm should ideally be placed in the image of the source in order to obtain a source diffraction. If a conventional diffraction is required, the diaphragm should ideally be placed in a plane conjugate to the focal plane of the image lens.

When it is required to modify the shape and increase the contour length of the diffraction spots by adjusting the incident beam, the incident beam may be rotated in conventional diffraction, or the incident beam may be translated in source diffraction. In source diffraction, the use of lenses can also give an incident beam shape that increases its contour length.

When it is required to modify the shape and increase the contour length of the diffraction spots by adjusting the sample, the sample can be rotated in conventional diffraction, or it can be translated in source diffraction, or the incident beam can even be “deformed” in source diffraction using lenses that will give a characteristic shape to the beam and thus increase its contour length.

When it is required to modify the shape and increase the contour length of diffraction spots by adjusting the detector, the detector (or diffracted beams) may be translated in source diffraction or in conventional diffraction.

Positioning of diffraction spots is facilitated firstly by the fact that, since diffraction spots have a recognisable shape instead of being simply dots or disk-shaped, the diffraction spots can be easily identified and no longer confused with spots corresponding to noise.

Furthermore, diffraction spots can now be positioned using algorithms that will recognise and position a particular shape corresponding to the shape of the diffraction spots.

Instead of being positioned by identifying maximum intensities as in the prior art, with the method according to the invention it is now possible to identify the shape and the contour of diffraction spots. In this way we can eliminate the need for correction due to Ewald's sphere, well known to those skilled in the art, and minimise dynamic phenomena in diffraction spots because the contour is less sensitive (because it contains more dots), than the position of a single maximum. Due to the disappearance of imprecision caused by the Ewald's sphere and minimisation of dynamic phenomena, it then becomes possible to consider diffraction spots as being periodic in reciprocal space, which also facilitates positioning of these diffraction spots.

It then becomes possible to use powerful mathematical correlation or lattice fitting methods to obtain good sensitivity firstly on measurements of the position of diffraction spots, and secondly on deformation measurements.

The diffraction spots obtained according to the invention have a particular shape and contour. In practice, the contour of diffraction spots may be blurred; therefore, diffraction spots can be positioned by choosing to position an isocontour, in other words a contour with the same light intensity. For example, an isocontour with the maximum value divided by 2 could be chosen. Since diffraction spots have very different intensities, the value of the isocontour is specific to each diffraction spot. Correlation algorithms could thus be used to precisely position the contours of diffraction spots either globally or individually.

There are different possible variants to modify the shape and to increase the contour length of diffraction spots according to the invention.

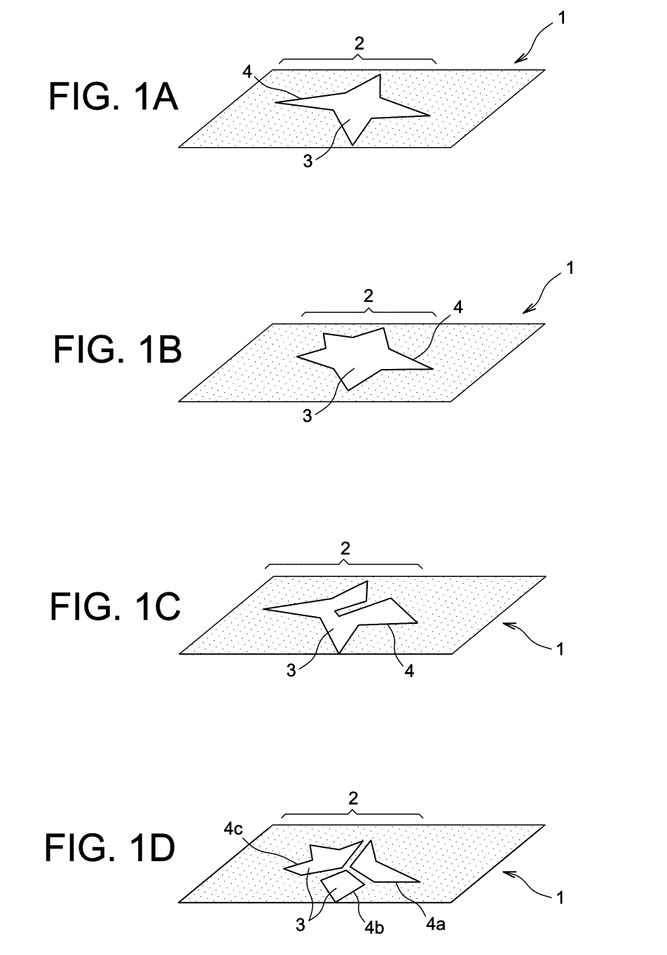

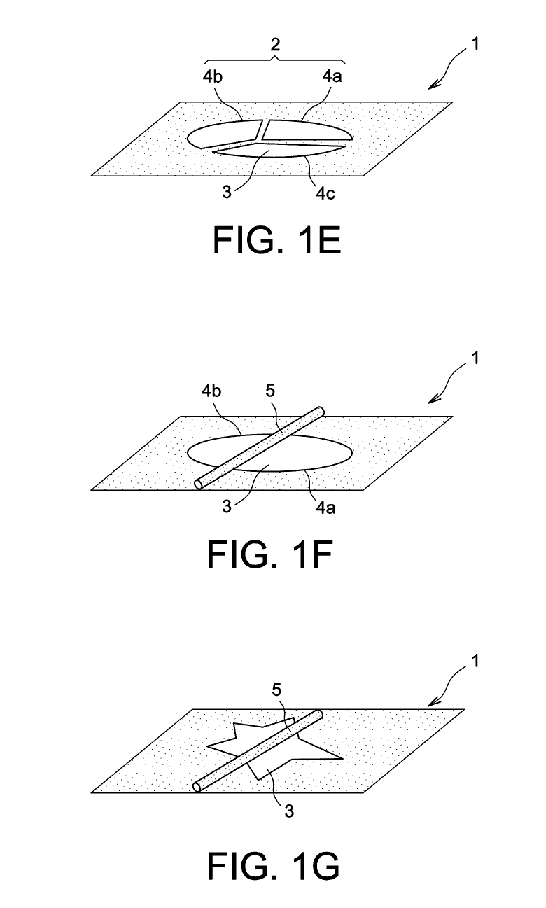

For example, a diaphragm with one or several openings forming a particular motif could be used. FIGS. 1A to 1G show different diaphragms 1 each comprising a motif 2 made by creating one or several openings 3 with various shapes.

Note that the motifs 2 shown in FIGS. 1A to 1G represent motifs belonging to diaphragms (plate comprising one or several openings 3), but each of the motifs of each of these figures could also represent a diffraction spot, since the shape of each diffraction spot is an “identical copy” of the motif 2 of the diaphragm used. This effect is particularly marked if the diaphragm is placed in the plane conjugate to the focal plane of the objective lens in the case of conventional diffraction, or on the contrary in the plane conjugate to the source image in the case of source diffraction. It is important to mention that there may be homothety between different diffraction spots in some Laue diffraction variants (white beam). Furthermore, in electron microscopy, some parts of spot contours may not be visible due to non-homogeneity of diffraction spots. In this case, all diffraction spots will have the same basic shape, but only some parts of the spot contours will be visible.

The diaphragm according to the invention may have one or several openings 3 instead of a single circular opening as is sometimes the case in prior art when a diaphragm is used (for example to increase the intensity of the incident beam). The shape, contour length and, when there are several openings, the layout of openings relative to each other, can create a particular motif. In passing through the opening(s) in the diaphragm, the beam will exit after having adopted the same shape as the motif formed by the opening(s) in the diaphragm and this motif will then appear in the diffraction spots; each diffraction spot will have the same shape and the same contour as the motif of the diaphragm, factored by a proportioning factor. For example in FIG. 1E, instead of having a contour length equal to the perimeter of a circle, there is a contour length that is the sum of the contours of each of the three portions forming the motif, in other words external parts shaped in the arc of a circle, but also internal parts (FIG. 1E shows two inner parts for each circle arc).

It is thus possible to have a motif composed of a single opening 3 for which the contour 4 has a recognisable shape, which is the case in FIGS. 1A and 1B showing a four-point star and a five-point star respectively, or on the contrary an undefined polygonal shape (FIG. 1C).

The motif may also be composed of several openings 3. Since the openings are at a distance from each other but are close relative to the total surface area of the diaphragm, the result is the same as if there were a single perforated opening. For example, there are three openings in FIG. 1D but the five-point star in FIG. 1B can be recognised, which in this case is separated into three distinct parts, each with its contour 4a, 4b, 4c.

The contour 4 in FIG. 1A is formed of four alternating convex and concave portions on a circumference. This contour has two planes of symmetry.

The contour in FIG. 1B is formed of five alternating convex and concave portions.

The contour in FIG. 1C is formed of four alternating convex and concave portions and does not have any plane of symmetry. The opening shown in FIG. 1C is a polygon.

There are many possible motif shapes. For example, a star-shaped opening would be possible: a star with regular or irregular points, an arbitrary polygon, two half-circles facing each other corresponding to a barred circle, in other words a circle on which a bar has been placed crossing the circle from one side to the other, a partially barred circle (in which the bar 5 leaves one edge of the circle but does not reach the opposite edge). Entirely barred or partially barred stars are also possible. For example, FIGS. 1E and 1F show a circle separated into three portions and a circle separated into two portions, respectively. FIG. 1G shows the star in FIG. 1B separated into two portions. Separation into portions may for example be done by placing a filament 5 across the opening in the diaphragm.

Existing equipment can be used to modify the shape and increase the contour length of diffraction spots. For example, some microscopes such as TITAN microscopes made by FEI comprise one or several condenser diaphragm holders in which one or several diaphragms, usually with a circular opening, can be placed. Two circular diaphragms placed in two condenser diaphragm holders can be used and the two diaphragms can be superposed so as to obtain diffraction spots with a particular shape (increased contour). One of the two circular diaphragms could also be replaced by an original star shape or by a nanometric wire placed across the opening of the remaining diaphragm. The result would then be the motif shown in FIG. 1F (wire passing through the circle of the diaphragm from one side to the other).

Note that when a diaphragm is used to modify the shape and the contour length of diffraction spots, the diaphragm has to be placed between the source of the beam and the sample. When the diffraction pattern is obtained using a set of lenses (conventional diffraction) (for example as is the case with electron microscope), it is preferable to place the diaphragm in a plane conjugate to the diffraction plane in which the detector is positioned. In this way, the diffraction spots will have a clearly defined contour in the diffraction plane.

On the other hand, if source diffraction is used instead, it is advantageous to position the diaphragm in the image plane of the source. In electronic microscopy, the image of the source is usually so small (a few tens of nanometers) that it is difficult to machine a diaphragm of this size. It is then preferable to use lenses (for example lenses of a spherical aberration probe to shape the incident beam. For example, a triangular shape can be obtained by introducing third order astigmatism (coefficient A2 in the CEOS Company software) at the probe.

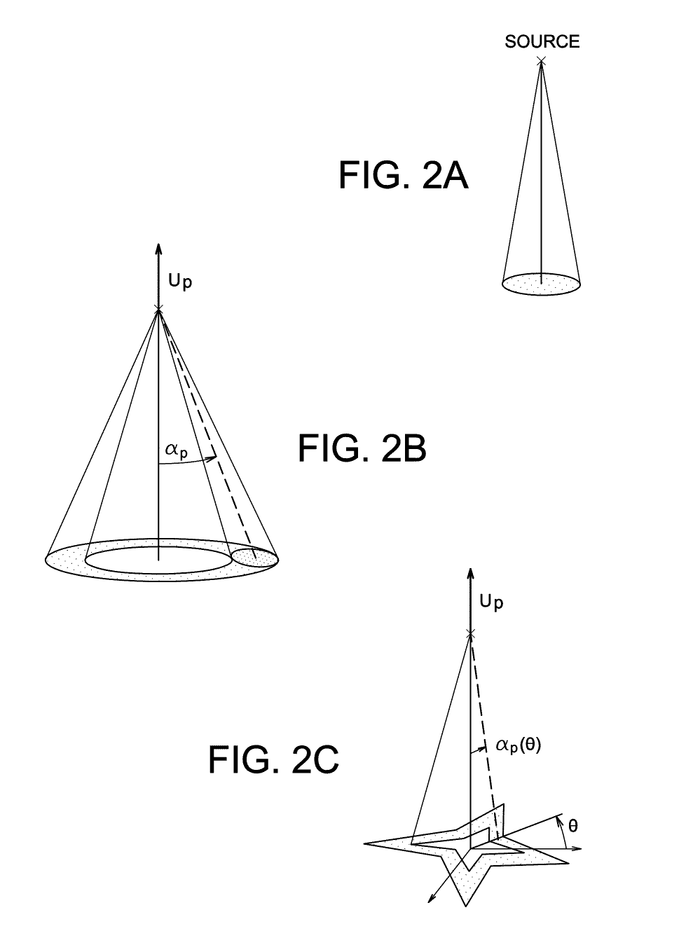

The shape can be modified and the contour length of diffraction spots can also be increased by precessing the incident beam, or equivalently the sample, by a fixed angle around an axis. FIG. 2A shows the conventional case of projection of a beam from a source onto a plane. It can be seen that a circle is obtained. In FIG. 2B, the beam precesses around the axis uₚ by an angle αₚ. The result is thus a diffraction spot in the form of a ring. The precession angle αₚ may for example be equal to 0.2°.

Precession of the incident beam can also vary as a function of the angular position of the beam. As shown in FIG. 2C, it can be seen that precession changes as a function of the angle θ of the beam: the result obtained is thus a diffraction spot in the form of a star with a hollow centre.

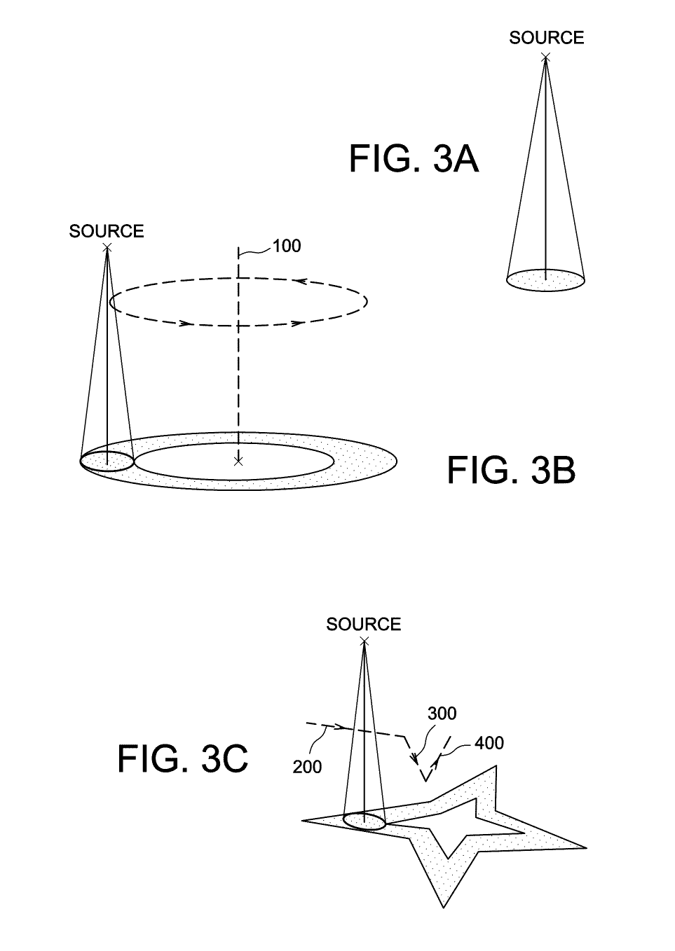

Instead of precessing the incident beam, either the sample or the diffracted beams can be translated. For example, FIG. 3B shows the case of a translation of the detector.

According to another embodiment, the shape and elongation of the contour length of the diffraction spots may be obtained by applying a translation movement to the diffracted beam or the detector. For example, diffraction spots in the shape of a ring star (star with a hollow centre) shown in FIG. 3C can be obtained by applying a translation movement to the detector, for example during a determined period, along the direction lines 200, 300, 400 so that when placed end to end, these lines would form the contour of a star. A circular or point diffraction spot can thus be formed that will be moved by translation. Translation of the detector is particularly suitable for an X-ray diffraction. Translation may also be obtained by using deflecting coils that will shift the diffracted beam rather than translate the detector.

Other shapes for diffraction spots are possible. For example, it is quite possible to apply precession only partly and thus not close the circle shown in FIG. 3B thus obtaining diffraction spots with a form resembling the letter C or in the shape of a comma.

Application of a translation or a rotation movement to the incident beam, to the detector, to the sample or to the diffracted beam has many advantages. Apart from the fact that it makes it possible to give a recognisable shape to diffraction spots so that they can be differentiated from noise, it also helps to avoid saturation of detector pixels and also obtain a resolution smaller than the pixels.

To illustrate the subject of the invention, we have simulated what a diffraction pattern according to the invention would look like.

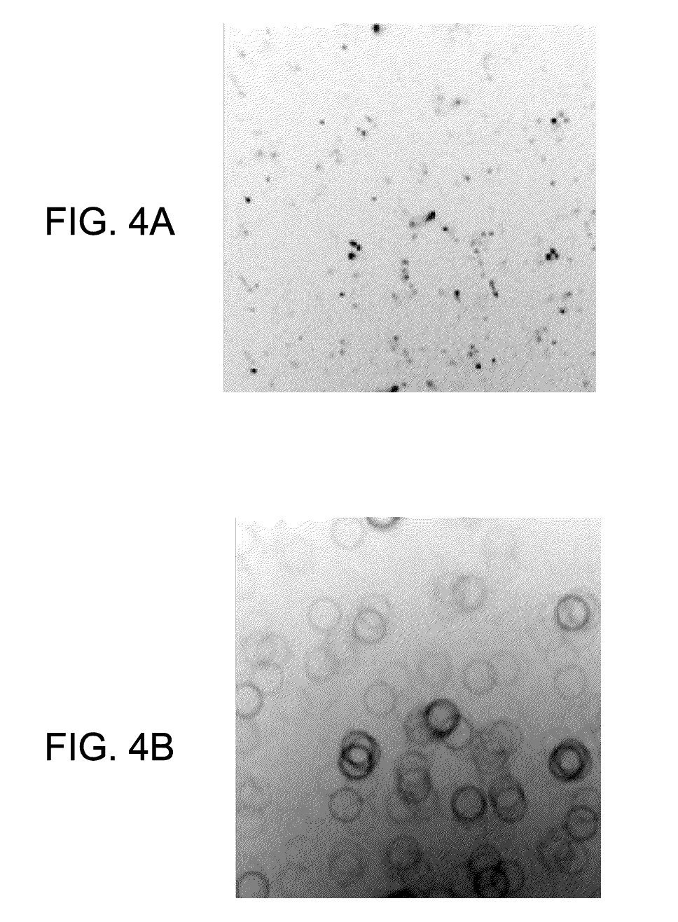

FIG. 4A shows a conventional Laue diffraction pattern. On this pattern, there is a multitude of dots corresponding to diffraction spots, and also to noise.

The result obtained by applying a set of translations to FIG. 4A (which is equivalent to applying translations to the detector) is the pattern shown in FIG. 4B. Elementary translations were chosen so as to form a circle in this example. It can be seen that all dots in FIG. 4A, noise or diffraction spots, result in a more or less intense circle in FIG. 4B, because the translations were made after acquisition of diffraction diagrams. Random spots in time, in other words noise, will not produce any motif on an experimental pattern. Diffraction spots that are themselves constant during translation of the beam, will describe the motif chosen by all the translations. Therefore the invention makes it possible to differentiate noise from the genuine signal.

We will now demonstrate the usefulness of the method according to the invention for measuring deformations present in a sample.

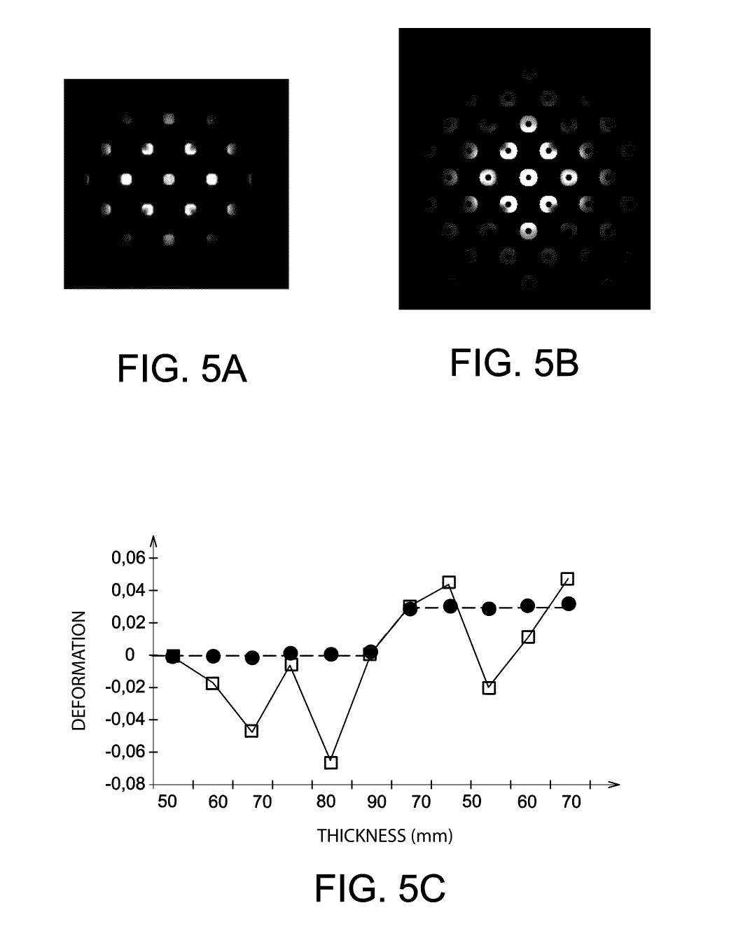

FIG. 5A shows the simulation of a typical diffraction pattern obtained by using a small electronic probe (typically 3 nm diameter) on a silicon sample observed along a direction [011]. It is observed that instead of being composed of point diffraction spots, the diffraction pattern is composed of disks that are not uniform because the size of the incident beam is very small and also because of multiple diffusion of electrons in silicon (so-called dynamic effect).

FIG. 5B shows the simulation of a diffraction pattern obtained by precessing the incident beam about the direction [011] by an angle of 0.05°. It can be seen that the diffraction spots, although they are not always uniform, are ring-shaped which makes them more easily detectable than the disks in FIG. 5A and therefore makes it possible to more precisely determine mesh parameters of the simulated crystal.

Finally, FIG. 5C shows deformation values (vertical axis) measured on diffraction patterns simulated from silicon samples with different thicknesses and different crystalline parameters (horizontal axis), these deformation values being determined either from diffraction patterns of the type in FIG. 5A with disk-shaped diffraction spots (curve for which measurement points are represented by squares) or from diffraction patterns of the type shown in FIG. 5B with ring-shaped diffraction spots (curve for which the measurement points are represented by solid disks), the real deformation being represented by a dashed line. By comparing the different curves in FIG. 5C, the advantage of increasing the contour length of diffraction spots is obvious when it is required to precisely measure crystalline parameters of a sample using electron diffraction.

1. A method to facilitate positioning of diffraction spots present on a diffraction pattern, the method comprising the following successive steps:
a) obtaining a diffraction pattern by illuminating at least part of a sample comprising at least one periodic zone by an incident radiation beam that can be diffracted by the at least one periodic zone of the sample, and by placing a detector on the path of the beam thus diffracted;
b) positioning of diffraction spots present on the diffraction pattern obtained in step a), by determining the spatial coordinates of these spots on the detector;
wherein step b) is facilitated by the use of means in step a) to modify the shape and increase the contour length of diffraction spots forming on the pattern, the means for modifying the shape and increasing the contour length of diffraction spots consisting of a plate comprising at least one opening, the plate being placed on the path of the beam between the source of the beam and the sample such that the beam passes through the at least one opening before reaching the face of the sample, the at least one opening forming a motif that is reproduced in each diffraction spot of the pattern obtained in step b).

2. (canceled)

3. The method according to claim 1, wherein each opening in the at least one opening has a contour formed by an alternation of concave portions and convex portions.

4. The method according to claim 1, wherein the motif is formed of a single opening, and the motif represents any plane geometric element with a surface area S and for which a contour length is greater than a contour length of a circle having the same area S.

5. The method according to claim 1, wherein the motif is formed of several openings, and the motif represents a set of plane geometric elements separated from each other, the sum of the contour lengths of the elements of the assembly being greater than a contour length of a circle for which the area is equal to the sum of the areas of the elements of the assembly.

6. The method according to claim 1, wherein the motif has a shape chosen from among a completely or partially barred circle, a star, a completely or partially barred star.

7. The method according to claim 6, wherein the means for modifying the shape and increasing the contour length of the diffraction spots further apply a translation movement to the beam, the sample, or the detector.

8. (canceled)

9. (canceled)

10. (canceled)

11. (canceled)

12. (canceled)

13. A method to facilitate positioning of diffraction spots present on a diffraction pattern, the method comprising the following successive steps:
a) obtaining a diffraction pattern by illuminating at least part of a sample comprising at least one periodic zone by an incident radiation beam that can be diffracted by the at least one periodic zone of the sample, and by placing a detector on the path of the beam thus diffracted;
b) positioning of diffraction spots present on the diffraction pattern obtained in step a), by determining the spatial coordinates of these spots on the detector;
wherein step b) is facilitated by the use of means in step a) to modify the shape and increase the contour length of the diffraction spots forming on the pattern, the means for modifying the shape and increasing the contour length of the diffraction spots uses one or several electromagnetic lenses.

14. A method to facilitate positioning of diffraction spots present on a diffraction pattern, the method comprising the following successive steps:
a) obtaining a diffraction pattern by illuminating at least part of a sample comprising at least one periodic zone by an incident radiation beam that can be diffracted by the at least one periodic zone of the sample, and by placing a detector on the path of the beam thus diffracted;
b) positioning of diffraction spots present on the diffraction pattern obtained in step a), by determining spatial coordinates of these spots on the detector;
wherein step b) is facilitated by the use of means in step a) to modify the shape and increase the contour length of the diffraction spots forming on the pattern, the means for modifying the shape and increasing the contour length of diffraction spots applying, either:
a rotation movement to the beam to make it precess by an angle αₚ about an axis uₚ passing through the source and through the sample;
a rotation movement to the detector to make it precess by an angle αₚ about an axis uₚ passing through the source and through the sample; or
a rotation movement to the sample to make it precess by an angle αₚ about an axis uₚ passing through the source and the detector;
the precession angle αₚ varying as a function of the angle θ, which corresponds to an orientation of the beam in a plane perpendicular to the axis uₚ relative to a fixed straight line located in this plane.
